(19) United States
(12) Patent Application Publication
(10) Pub. No.: US 2025/0079844 A1
(43) Pub. Date: Mar. 6, 2025

(54) Composite Power Station Systems and Methods

(71) Applicant: DD Dannar LLC, Muncie, IN (US)

(72) Inventors: Gary Don Dannar, Muncie, IN (US); Stephen T. Hung, Auburn, AL (US)

(73) Assignee: DD Dannar LLC, Muncie, IN (US)

(21) Appl. No.: 18/792,013

(22) Filed: Aug. 1, 2024

Related U.S. Application Data
(63) Continuation of application No. 17/259,035, filed on Jan. 8, 2021, now abandoned.
(60) Provisional application No. 62/696,194, filed on Jul. 10, 2018.

(51) Int. Cl. H02J 3/32; B60L 8/00; B60L 58/10

(52) U.S. Cl. CPC H02J 3/322; B60L 8/003; B60L 8/006; B60L 58/10; B60L 2240/72

(57) ABSTRACT

A method and stand-alone composite power station having multiple power sources including one or more photovoltaic panels, wind turbines, and/or generators, detached from a utility grid. The composite power station supplies power to the composite energy storage arrangement for supplying power to equipment, vehicles, and/or power consumers. The power station includes a composite energy storage arrangement having at least one stationary element and at least one mobile element. A composite power import processing arrangement supplies power to at least one of the stationary element and the mobile element under allocation control of a composite power import allocation arrangement, and a composite power export processing arrangement supplies power from at least one stationary element and mobile element under allocation control of a composite power export allocation arrangement for downstream use by a vehicle, equipment, and/or power consumer.

### FIELD

Implementations of this disclosure relate to, among other things, systems and methods concerning composite power stations having mobile and/or stationary power and energy storage components.

### BACKGROUND

With the proliferation of electric-powered vehicles and equipment, charging requirements for such have increased. Ordinarily, electricity for such charging is provided by conventional grid power and/or perhaps power entailing combustion processes involving boilers, generators, etc. While such arrangements may provide adequate power for charging, they may involve the direct and/or indirect creation of pollutants in the form of combustion products/by-products, or in the case of nuclear power, risks of radiation leaks, spent fuel storage issues, etc.

Accordingly, a need exists for substantially emission-free systems and methods for charging vehicles and equipment.

### SUMMARY

In an implementation of the present disclosure, a stand-alone composite power station (having multiple power sources including one or more photovoltaic panels, wind turbines, and/or generators), detached from a utility grid, supplies power to the composite energy storage arrangement for supplying power to equipment, vehicles, and/or power consumers. The power station includes a composite energy storage arrangement having at least one generally stationary element and at least one mobile element. A composite power import processing arrangement supplies (under allocation control of a composite power import allocation arrangement) power to at least one of the stationary element and the mobile element, and a composite power export processing arrangement supplies (under allocation control of a composite power export allocation arrangement) power from at least one stationary element and mobile element for downstream use by a vehicle, equipment, and/or power consumer. To a certain extent, existing vehicle-to-grid (V2G) projects that also have stationary storage may provide the potential for this nature of functionality, but V2G systems generally do not treat the mobile components as known mobile energy assets that also serve as power processing assets.

It is to be understood that while the above power station is not connected to a utility grid for normal operational purposes, such power station could nevertheless be connected to a utility grid during times when the power station is down for repair, maintenance, etc. and/or in the event weather conditions or other operational considerations cause the power output from the power station to be insufficient for the needs to be supplied by the power station. It is to be further understood that as used herein, “stationary” includes temporary and/or permanent fixed equipment, or, assets, as well as substantially temporary and/or permanent fixed assets and can include assets which are terrestrially-based, marine-based, space-based, and/or based in the air, i.e., in the atmosphere. For example, a relatively static dirigible or other aerially-situated assets could be equipped with solar energy-gathering panels and/or surfaces and provide stored electricity suitable for charging electrically powered aerial drones or aircraft. Further, marine-based assets could be equipped with solar energy-gathering panels and/or surfaces and provide stored electricity suitable for charging electric marine vehicles and/or watercraft. And similarly, space-based assets could be equipped with solar energy-gathering panels and/or surfaces and provide stored electricity suitable for charging electric space-based vehicles and/or spacecraft.

In one implementation, the present disclosure includes a composite power station that is stand-alone, substantially or fully detached from a conventional power grid, and that captures solar energy and energy from one or more additional sources apart from the grid and energy produced from combustion sources, and nuclear sources. In one implementation, the present disclosure includes the composite power station that providing Level 1, 2, and 3 chargers.

In one implementation, the present disclosure includes a composite power station that includes mobile and/or stationary power and energy storage components and for which the mobile components, such as an electrically-powered mobile work platform (“MWP”) as disclosed in U.S. Provisional Patent Application No. 62/682,145, of Dannar et al., filed Jun. 7, 2018, the entirety of which is incorporated herein by reference, or multiple such MWPs of various configurations, arranged to provide flexibility of operation, capacity, and power delivery. The MWPs serve as mobile energy storage and power export elements. In one implementation, the relationship of MWPs and stationary power and energy storage components may take a form as shown in FIG. 1 hereof. By way of example only, in one implementation, a MWP includes a mobile platform having a source of electricity, such as battery storage, that powers an electric drive system for powering the power output device. The platform has a first end and a second end generally opposite the first end. A first attachment interface is connected to the first end, and a second attachment interface, substantially operationally equivalent to the first attachment interface, is connected to the second end. The first end of the platform also includes a first steering mechanism, and the second end includes a second steering mechanism substantially operationally equivalent to the first steering mechanism, whereby the platform is configured to be propelled and steered in a first direction and propelled and steered in a second direction generally opposite the first direction by the first and second steering mechanisms, respectively. Such an MWP may include storage and power access capabilities of infrastructure energy storage, but by being mobile and not stationary, constructed infrastructure, deployment of such MWPs is likely much easier and faster, particularly with respect to site location for a composite power station, where permitting, compliance with codes, construction planning, lead time and execution, inspections, etc. may be required.

In another implementation, the composite power stations described herein include one or more mobile energy storage components which can be added or removed from such composite power station, thereby decreasing the risks of investment capital and/or usability due to potential miss-sizing of energy storage during design of a composite power station. Mobile energy components can be easily added if demand for power from such composite power station and/or for energy storage increase, and similarly, such energy storage components may be taken out of service and/or moved elsewhere for use or storage if the incremental amount of energy storage provided by such mobile energy storage component is not necessary.

In another implementation of a composite power station of the present disclosure, an MWP may be included having the ability to carry attachments at one or more ends thereof and may include of maximum power point tracking (MPPT) equipment and/or electrical vehicle supply equipment (EVSE) as part of the MWP configuration. Inclusion of MPPT and/or EVSE results in expansion of the value of the MWP as a mobile substitute asset in lieu of fixed, stationary, traditional power generation/storage components, potentially opening a number of degrees of freedom for flexibility and/or optimization of application of the MWP and/or such power station.

In another implementation, such as depicted in FIG. 2, a relationship exists between seven elements of implementation and eight elements of logic or function of optimization/sizing and/or self-verification related to each element of implementation. Such physical implementation elements include composite energy storage, battery configurations, capacitors, and other electric storage devices, which could be stationary and/or mobile; composite power import processing, which could be across various source types, such as grid power, solar power, wind power, geothermal power, tidal power, etc.; composite power export processing, from various platforms, such as vehicles, battery storage, grid-ties, via direct current (DC) and/or alternating current (AC); composite power import allocation to stationary and/or mobile storage; composite power export allocation from stationary and/or mobile storage; multiple types of power sources, such as photovoltaic, wind, generators, etc.; and/or multiple types of power consumers, such as stationary, mobile, fleet, private, etc.

The logic structure for the sizing of the aforementioned physical implementation elements for a composite power station includes a logic system for composite energy storage, such as for the sizing of energy storage capacity; a logic system for composite power import processing, such as how much power should be imported from a stationary source and/or mobile source; a logic system for composite power export processing, such as how much power should be exported to a stationary source and/or a mobile source; a logic system for composite power import allocation, such as how much power to import from a stationary and/or mobile source; a logic system for composite power export allocation, such as how much power should be exported from a stationary and/or a mobile source; a logic system for multiple types of power sources, such as how much power should be utilized from particular types of sources, including mobile and/or stationary; a logic system for multiple types of power consumers, such as how much and what types of devices from which power is to be imported and/or exported; and/or an integrated oversight and control system for monitoring and controlling some or all of the foregoing logic systems and physical implementation elements.

In one implementation, the present disclosure includes physical implementation elements and elements of logic or function of optimization of the physical implementation elements which are connectively configured between the implementation elements and associated software logic.

More specifically, in one implementation, the present disclosure includes composite energy storage comprised of stationary and mobile components. The value of having such a combination could include:
(i) a decreasing of risk associated with potential improper sizing of the energy storage component of a zero-emission power station; and
(ii) reduction of time and expense related to construction of stationary energy storage infrastructure.

In an implementation including composite power importation, such composite power import processing means processing, by mobile and stationary processing components, of source power into one or more forms suitable for storage in the composite energy storage element. In photovoltaic (PV) power systems, power import processing from the PV source generally takes the form of maximum power point tracking power converters. As with the mobile energy storage components, mobility of at least some component of import processing should reduce the risk of improper sizing and also reduce infrastructure construction time. This component of processing is usually part of power-source-to-grid system, and in a V2G arrangement, the relationship between the vehicle and grid is that of the vehicle-as-storage, drawing power from the grid, and not acting as processor of source power to the grid.

In one implementation, the present disclosure includes composite power export processing of composite stored energy into one or more forms suitable for end use. In PV electric vehicle charging systems, power export processing takes the form of power converters that feed the electric vehicle supply equipment (EVSEs). As with the mobile energy storage components and power import processing, mobility of at least some component of export processing should reduce the risk of improper sizing and also reduce infrastructure construction time.

In certain implementations, the present disclosure includes composite power import allocation of source power to either mobile or stationary energy storage components and what proportion or amount that goes to each. Regardless of whether a system uses a single processor or multiple processors for a calculation process, each composite power station arrives at a single, common import allocation for a planned period of time.

In certain implementations, the present disclosure includes composite power export allocation of export power from either mobile or stationary energy storage components, and what proportion or amount comes from each to feed power export processors. In a fashion similar to composite power import allocation, each composite power station arrives at a single, common export allocation for a planned period of time.

In certain implementations, the present disclosure includes multiple/multiple-type power sources of power feeding the composite power station whose nature of output and interface requirements dictate the requirements of the power import processing equipment. Nothing precludes use of only a single type of power source, but use of multiple types of sources may improve the ability of a power station to collect and supply power across varying environmental, weather, and/or demand conditions.

In certain implementations, the present disclosure addresses power consumers as the users of power from the composite power station whose nature of use and the interface requirements being dictated by such consumer requirements of the power export processing equipment. Nothing precludes supplying power to only a single type of power consumer, but the ability to supply multiple types of consumers may improve the value of a power station across varying consumer power usage patterns.

In certain implementations, the present disclosure includes a logic structure for composite energy storage configurations and logic and/or algorithms for station-level systems for optimizing mobile energy to determine the best amount of mobile energy storage for a composite power station across a planned period of time. It is generally preferable to avoid removal and/or repeated installation of stationary storage components of a power station, so the combination of stationary storage elements at a particular composite power station would generally be fixed, and the mobile storage components of MWPs and/or other vehicles provides the ability to either increase energy storage capacity or decrease temporarily unneeded capacity and for redeployment as mobile work assets.

In certain implementations, the present disclosure includes software logic and/or algorithms for composite power import processing to determine the optimized combination of power import processing equipment to process composite source power to a form suitable for accumulation of energy in composite energy storage.

In certain implementations, the present disclosure includes software logic and/or algorithms for composite power export processing to determine the optimized combination of power export processing equipment to convert composite stored energy to one or more forms suitable for projected power users across a planned period of time.

In certain implementations, the present disclosure includes software logic and/or algorithms for composite power import allocation that determines allocation of source power to either mobile or stationary energy storage components and what proportion or amount goes to each across a planned window of time.

In certain implementations, the present disclosure includes software logic and/or algorithms that determine allocation of export power from either mobile or stationary energy storage components and what proportion or amount goes to which power export processor(s) across a planned period of time.

In certain implementations, the present disclosure includes software logic and/or algorithms for composite multiple/multiple-type power sources to project the most likely optimal production of power from the combination of sources of a composite power station across a planned period of time. Regardless of whether a system uses a single processor or multiple processors to project the optimal combination, each composite station arrives at a single projection of an optimized combination of sources for the planned period of time. Examples of related logic for analysis are available from USDOE/NREL, such as PVWatts (https://pvwatts.nrel.gov/), which estimates “the energy production and cost of energy of grid-connected photovoltaic (PV) energy systems . . . ” and/or System Advisor Model (SAM: https://sam.nrel.gov/), which “is a performance and financial model designed to facilitate decision making for people involved in the renewable energy industry”, the foregoing PVWatts and System Advisor Model being incorporated herein by reference thereto.

In certain implementations, the present disclosure includes software logic and/or algorithms to project the most likely consumption of power from the combination of consumers who will use power across a planned period of time. Regardless of whether a system uses a single processor or multiple processors to project the combination, each composite station arrives at a single projection of most likely combination of consumers for the planned period of time.

In certain implementations, the present disclosure includes one or more software logic and/or algorithms integrated oversight and control configurations which provide overarching software logic or algorithms that monitor and assess if the one or more of the foregoing elements yield interrelationship behaviors and overall functionality and performance to provide power supply capabilities that meet power consumer needs. This amounts to overall process monitoring and feedback assessment and control over the entire composite power station as an integrated system.

In one implementation of the present disclosure, an exemplary composite power station is provided for use in connection with equipment items, vehicles, and power consumers, with the composite power station including a composite energy storage arrangement having at least one stationary element and at least one mobile element and a composite power import processing arrangement configured to supply power to at least one of the stationary element and the mobile element. A composite power export processing arrangement is configured to export power from at least one of the stationary element and the mobile element to at least one of the equipment items, vehicles, and power consumers, and a composite power import allocation arrangement is communicatively connected to at least one of the stationary element and the mobile element and is configured to selectively allocate power imported to at least one of the stationary element and the mobile element. A composite power export allocation arrangement is communicatively connected to at least one of the stationary element and the mobile element and is configured to selectively export power from at least one of the stationary element and the mobile element. And, at least one of a photovoltaic panel, a wind turbine, and a generator is provided which is configured to supply power to the composite energy storage arrangement.

In certain implementations of the present disclosure, the exemplary composite power station may include one or more logic arrangements that: size capacities of the composite energy storage arrangement; determine how much power is to be imported by the composite power import processing arrangement; determine how much power is to be exported from composite power import processing arrangement; determine how much power is to be imported to the stationary element and the mobile element; determine how much power is to be allocated from the stationary element and the mobile element; determine how much power is to be taken from the stationary element and the mobile element; and/or determine how much power is to be provided to specific or predetermined power consumers. Additionally, an integrated oversight and control logic arrangement may also be provided to such exemplary composite power station.

In another implementation of the present disclosure, an exemplary method is provided which includes the steps of: providing a composite energy storage arrangement having at least one stationary element and at least one mobile element and a composite power import processing arrangement configured to supply power to at least one of the stationary element and the mobile element; providing a composite power export processing arrangement configured to export power from at least one of the stationary element and the mobile element to at least one of the equipment items, vehicles, and power consumers; providing a composite power import allocation arrangement configured to selectively allocate power imported to at least one of the stationary element and the mobile element; providing a composite power export allocation arrangement configured to selectively export power from at least one of the stationary element and the mobile element; providing at least one of a photovoltaic panel, a wind turbine, and a generator configured to supply power to the composite energy storage arrangement configured to supply power to the composite energy storage arrangement; providing a first logic arrangement that determines at least one of the amount of power to be imported to the stationary element and the mobile element, the amount of power to be allocated from the stationary element and the mobile element, the amount of power to be taken from the stationary element and the mobile element; providing an integrated oversight and control logic arrangement; and using the integrated oversight and control logic arrangement to control multiple ones of the composite energy storage arrangement, the composite power import processing arrangement, the composite power export processing arrangement, the composite power import allocation arrangement, and the composite power export allocation arrangement.

The exemplary method may also include the steps of: providing a first logic arrangement that determines at least one of the amount of power to be imported to the stationary element and the mobile element, the amount of power to be allocated from the stationary element and the mobile element, the amount of power to be taken from the stationary element and the mobile element; providing an integrated oversight and control logic arrangement; and using the integrated oversight and control logic arrangement to control at least two different ones of the following: the composite energy storage arrangement; the composite power import processing arrangement; the composite power export processing arrangement; the composite power import allocation arrangement; the composite power export allocation arrangement; and the first logic arrangement.

The exemplary method may further include one or more of the steps of providing: a second logic arrangement that sizes capacities of the composite energy storage arrangement; a third logic arrangement that determines how much power is to be imported by the composite power import processing arrangement; a fourth logic arrangement that determines how much power is to be exported from composite power import processing arrangement; a fifth logic arrangement that determines how much power is to be imported to the stationary element and the mobile element; a sixth logic arrangement that determines how much power is to be taken from the stationary element and the mobile element; and/or a seventh logic arrangement that determines how much power is to be provided to predetermined power consumers, and additionally, the step of and using the integrated oversight and control logic arrangement to control at least two different ones of the following: the composite energy storage arrangement, the composite power import processing arrangement, the composite power export processing arrangement, the composite power import allocation arrangement, the composite power export allocation arrangement, the first logic arrangement, the second logic arrangement, the third logic arrangement, the fourth logic arrangement, the fifth logic arrangement, the sixth logic arrangement, and the seventh logic arrangement.

The scalability of composite power stations of the present disclosure allows the ready and flexible tailoring of the stored electricity needed for fleets of commercial, municipal, government, agricultural, military, etc., while simultaneously generating little to no emissions either directly onsite, or indirectly (due to upstream power generation combustion products emissions inherent to much of grid power).

The features, functions, and advantages that have been discussed can be achieved independently in various examples or may be combined in yet other examples, further details of which can be seen with reference to the following description and drawings.

### BRIEF DESCRIPTION OF THE DRAWINGS

Having thus described exemplary aspects of the disclosure in general terms, various features and attendant advantages of the disclosed concepts will become more fully appreciated as the same becomes better understood when considered in conjunction with the accompanying drawings, which are not necessarily drawn to scale, in which like reference characters designate the same or similar parts throughout the several views, and wherein:

FIG. 1 is a schematic view of an example of one implementation of a charging system of the present disclosure; and

FIG. 2 is a schematic representation of an example of an implementation of elements used in a charging system of the present disclosure.

### DETAILED DESCRIPTION

Examples of the present disclosure will now be described more fully hereinafter with reference to the accompanying drawings, in which some, but not all examples of the disclosure are shown. Indeed, various exemplary aspects of the disclosure may be embodied in many different forms and should not be construed as limited to the examples set forth herein. Rather, these examples are provided so that this disclosure will be thorough and complete and will fully convey the scope of the disclosure to those skilled in the art. Like reference numerals refer to like elements throughout.

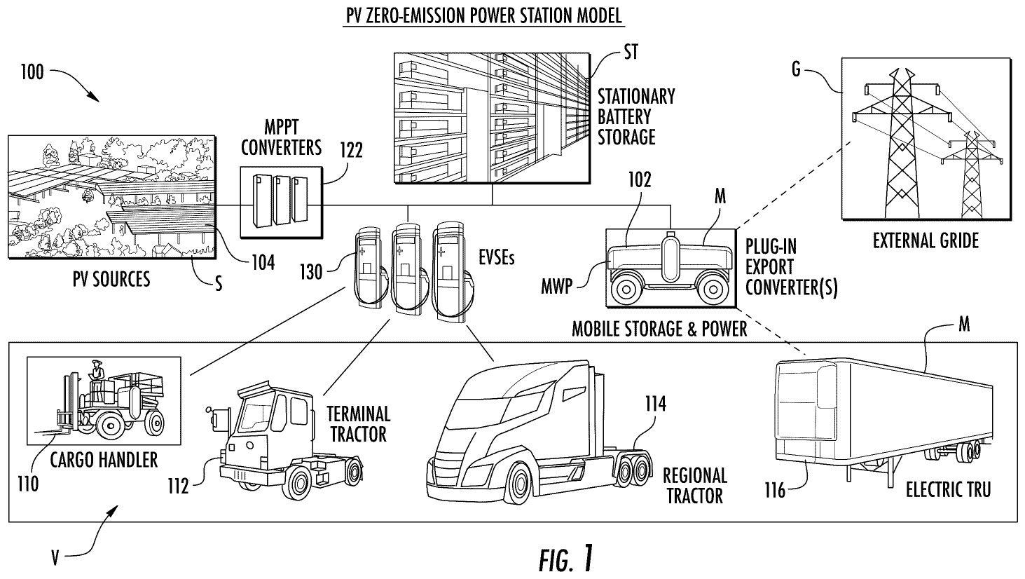

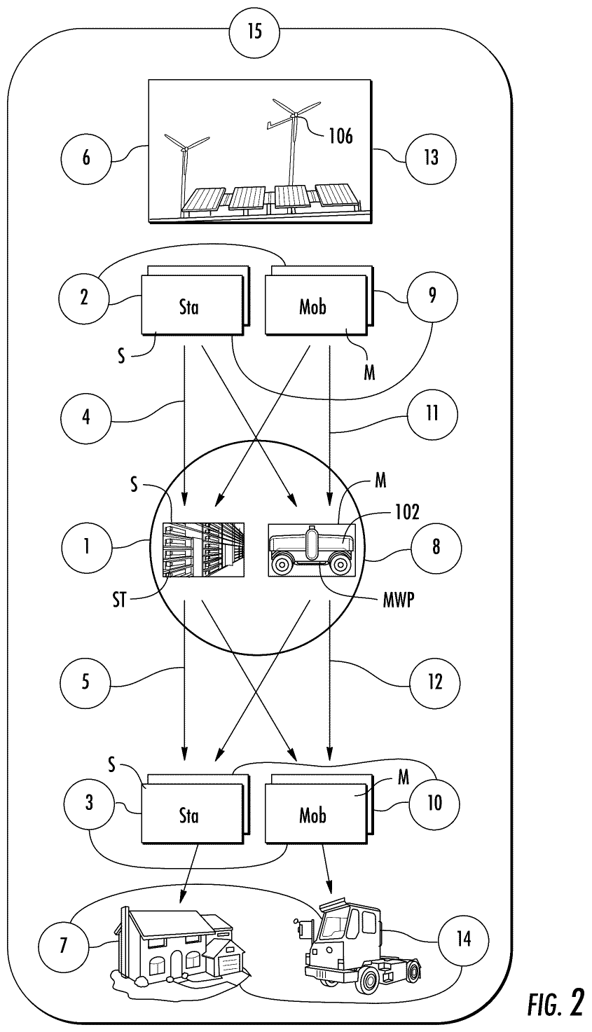

Referring now to FIGS. 1 and 2, one implementation of a composite power station, generally 100, of the present disclosure is illustrated. Composite power station 100 includes mobile power, generally M, and/or stationary power, generally S, and energy storage elements, or components. Mobile power elements may include one or more electrically-powered mobile work platforms (“MWPs”), generally 102. MWPs of various configurations may be arranged to provide flexibility of operation, capacity, and power delivery. MWPs can serve as mobile energy storage and power export elements as needed, and the relationship of MWPs and stationary power and energy storage ST components is shown in FIG. 1.

Energy storage components, such as MWPs, can be added or removed from such composite power station 100, thereby decreasing the risks of investment capital being used inefficiently and/or unusable due to potential inappropriate sizing of energy storage elements during design of a composite power station 100. Mobile energy components M can be readily added if demand for power from such composite power station 100 and/or for energy storage increase, and similarly, such energy storage components ST may be taken out of service and/or moved elsewhere for use or storage if the incremental amount of energy storage provided by such mobile energy storage component ST is not necessary.

Mobile energy components M may include one or more MWPs, as discussed above, and/or other electric-powered or hybrid vehicle or mobile device, including, but not limited to, cargo handlers 110, terminal tractors 112, regional tractors 114, electric transportation refrigeration units 116, etc. Storage ST may include storage and power access capabilities of infrastructure energy storage, but components M, by being mobile and not stationary, constructed infrastructure, are much easier to deploy quickly. This can be of paramount importance with respect to quickly establishing a power station 100 in response to an emergency event, military usage, etc., and for site location where permitting, compliance with codes, construction planning, inspections, etc. inordinately delaying lead times and ultimate construction, startup and power delivery experienced by conventional power plants.

In another implementation of a composite power station 100, a MWP may be included having the ability to carry attachments at one or more ends thereof and may include inclusion of maximum power point tracking (MPPT) equipment and converters 122 and/or electrical vehicle supply equipment (EVSE) 130 as part of the MWP configuration. Inclusion of MPPT 122 and/or EVSE 130 results in expansion of the value of the MWP as a mobile substitute asset in lieu of fixed or substantially fixed, stationary, traditional power generation/storage components, and potentially opens a number of degrees of freedom for flexibility and/or optimization of application of the MWP and/or such power station 100.

As shown in FIG. 2, in composite power station 100, a relationship exists between seven elements of implementation and eight elements of logic for optimization/sizing and/or self-verification related to each element of implementation. Briefly, the seven elements of implementation include composite energy storage arrangement, generally 1, which includes both stationary and mobile (such as an MWP and/or stationary battery storage) elements. Composite power import processing arrangement 2 includes stationary S and mobile M sources. Composite power export processing arrangement 3 is directed to the export of power for charging and/or operation of equipment and/or vehicles, including consumer uses such as residential, passenger vehicle charging, golf cart charging, etc. Composite power import allocation arrangement 4 is directed to importation of power to station 100 from stationary S and/or mobile M storage (which could include for example one or more MWPs, or other mobile equipment, such as cargo handlers 110, terminal tractors 112, regional tractors 114, trailer 116, etc. (FIG. 1)). Composite power export allocation arrangement 5, allocates power from either stationary S or mobile M storage and multiple types of power sources, generally 6, include sources such as photovoltaic panels 104, wind turbines 106 (FIG. 2), generators, etc. for supplying power to station 100, and multi-type power consumers, generally 7, including power users, such as stationary, mobile, fleet, private users, etc.

Briefly, the eight elements of logic or function for sizing of one or more implementations include logic arrangement and/or software 8 for composite energy storage arrangement 1, namely, for sizing of capacities. Logic arrangement and/or software 9 for composite power import processing arrangement 2 determines how much power is to be imported from stationary S sources versus mobile M sources. Logic arrangement and/or software 10 for composite power export processing arrangement 3 determines how much power is to be exported from stationary S versus mobile M sources. Logic arrangement and/or software 11 for composite power import allocation arrangement 4 determines how much power is to be imported from stationary S versus mobile M sources. Logic arrangement and/or software 12 for composite power export allocation arrangement 5 determines how much power is to be allocated from stationary S to mobile M sources. Logic arrangement and/or software 13 for multi-type power sources 12 determines how much power is to come from particular type of sources, i.e., mobile M and/or stationary S source. Logic arrangement and/or software 14 for multi-type power consumers 7 determines how much power is to be provided to which particular type(s) of consumers, and integrated oversight and control logic arrangement and/or software 15 controls one or more of the elements above denoted by reference characters 1 through 14 above.

More specifically, composite energy storage arrangement 1 is comprised of stationary and mobile components. The value of having such a combination could include:
(i) decreasing of risk associated with potential improper sizing of the energy storage component of a zero-emission power station; and
(ii) reduction of time and expense related to construction of stationary energy storage infrastructure. While existing vehicle-to-grid (V2G) projects have stationary storage that could have the potential of providing for this nature of functionality, V2G systems generally do not treat the mobile components as known mobile energy assets that also serve as power processing assets.

Composite power import processing arrangement 2 includes processing, by mobile and stationary processing components, of source power into one or more forms suitable for storage in the composite energy storage element. In photovoltaic (PV) power systems, generally 104, power import processing from the PV source generally takes the form of maximum power point tracking (MPPT) power converters. As with the mobile energy storage components, mobility of at least some component of import processing should reduce the risk of improper sizing and also reduce infrastructure construction time. This component of processing is usually part of power-source-to-grid system, and in a V2G arrangement, the relationship between the mobile source M, which may be a vehicle, generally V, and grid, is that of the vehicle-as-storage drawing power from the grid and not acting as processor of source power to the grid.

Composite power export processing arrangement 3 includes composite power export processing of composite stored energy into one or more forms suitable for end use. In PV electric vehicle charging systems, power export processing takes the form of power converters that feed or are the electric vehicle supply equipment (EVSEs) 130. As with the mobile energy storage components and power import processing, mobility of at least some component of export processing should reduce the risk of improper sizing and also reduce infrastructure construction time.

Composite power import allocation arrangement 4 includes source power to either mobile or stationary energy storage components and determines the proportion or amount that goes to each. Regardless of whether a system uses a single processor or multiple processors for a calculation process, composite power station 100 may be configured to generally arrive at a single, common import allocation for a planned period of time.

Composite power export allocation arrangement 5 includes allocation of export power from either mobile M or stationary S energy storage components and determining the proportion or amount that comes from each to feed power export processors. In a fashion similar to composite power import allocation, each composite power station must arrive at a single, common export allocation for a planned period of time.

Multi-type power sources 6 includes multiple/multiple-type power sources of power feeding the composite power station whose nature of output and interface requirements dictate the requirements of the power import processing equipment. Nothing precludes use of only a single type of power source, but use of multiple types of sources may improve the ability of a power station to collect and supply power across varying environmental conditions.

Multi-type power consumers 7 includes multiple/multiple-type power consumers, namely, the users of power from the composite power station 100 whose nature of use and interface requirements dictate the requirements of the power export processing equipment. Nothing precludes supplying power to only a single type of power consumer, but the ability to supply multiple types of consumers may improve the value of a power station across varying consumer power usage patterns.

Logic arrangement and/or software 8 includes logic for composite energy storage arrangements 1 and logic or algorithms for station-level systems for optimizing mobile energy to determine the best amount of mobile energy storage for a composite power station 100 across a planned period of time. It is generally preferable to avoid removal and/or repeated installation of stationary storage components of a power station 100, so the combination of stationary storage elements at a particular composite power station would generally be fixed, and the mobile storage components of MWP form would provide the ability to either increase energy storage capacity or decrease temporarily unneeded capacity and for redeployment as mobile work assets.

Logic arrangement and/or software 9 includes use of software logic and/or algorithms for composite power import processing arrangements 2 to determine the best combination of power import processing equipment to process composite source power to a form suitable for accumulation to energy storage in composite energy storage.

Logic arrangement and/or software 10 for composite power export processing arrangement 3 determine the best combination of power export processing equipment to convert composite stored energy to one or more forms suitable for projected power users across a planned period of time.

Logic arrangement and/or software 11 for composite power import allocation arrangement 4 determines allocation of source power to either mobile M or stationary S energy storage components and what proportion or amount goes to each across a planned window of time.

Logic arrangement and/or software 12 for composite power export allocation arrangement 5 determines allocation of export power from either mobile or stationary energy storage components and what proportion or amount goes to which power export processor(s) across a planned window of time.

Logic arrangement and/or software 13 for multi-type power sources 12 projects the most likely optimal production of power from the combination of sources of a composite power station across a planned period of time. Regardless of whether a system uses a single processor or multiple processors to project the optimal combination, each composite station arrives at a single projection of an optimized combination of sources for the planned period of time.

Logic arrangement and/or software 14 for multi-type power consumers 7 projects the most likely consumption of power from the combination of consumers who will use power across a planned period of time. Regardless of whether a system uses a single processor or multiple processors to project the combination, each composite station arrives at a single projection of most likely combination of consumers for the planned period of time.

Integrated oversight and control logic arrangement and/or software 15 provides overarching software logic or algorithms that monitor and assess if the one or more of the foregoing elements denoted by reference characters 1 through 14 yield interrelationship behaviors and overall functionality and performance to provide power supply capabilities that meet power consumer needs. This amounts to overall process monitoring and feedback assessment and control over the entire composite power station as an integrated system. Such integrated oversight and control monitors the entire composite power station and takes into account seasonal change (and the corresponding energy needs of both the power system 100 and components, or, implements connected to power station 100), of PV panel efficiencies. Such integrated system also allows, given the number of internal combustion (IC) vehicles and/or equipment items (such as diesel, gasoline, and propane vehicles), and the individual fuel usage of such vehicles and/or equipment for the precise number of solar panels required for a power station 100, the number and types of chargers required, and the required battery storage capacity, thereby allowing the power station 100 to be properly specified for construction and deployment. The integrated system also allows for the precise electrical flow into and out of vehicles and equipment items connected to power station 100.

The systems and/or methods described herein provide composite power stations having flexible configurations that reduce or eliminate the necessity of connection to a power grid for providing energy import, storage, and export while still being able to satisfy a broad range of uses.

Although specific features of various examples of the invention may be shown in some drawings and not in others, this is for convenience only. In accordance with the principles of the invention, any feature of a drawing may be referenced and/or claimed in combination with any feature of any other drawing.

This written description uses examples to disclose various examples, which include the best mode, to enable any person skilled in the art to practice those examples, including making and using any devices or systems and performing any incorporated methods. The patentable scope is defined by the claims, and may include other examples that occur to those skilled in the art who may or may not choose to draw from the following: U.S. Provisional Patent application No. 62/682,145, of Dannar et al, filed Jun. 7, 2018 and Solar Powered Charging Station, Kondracki, Ryan; Collins, Courtney; Habbab, Khalid, ASEE 2014 Zone I Conference, Apr. 3-5, 2014, University of Bridgeport, Bridgeport, CT, USA, http://www.ascc.org/documents/zones/zone1/2014/Student/PDFs/125.pdf; and GoSolarKB, www.gosolarkb.com, the entirety of all of the foregoing being incorporated herein by reference.

Although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. While specific terms are employed herein, they are used in a generic and descriptive sense only and not for purposes of limitation.

What is claimed is:

1. A composite power station for use in connection with equipment items, attachments, vehicles, and power consumers, the composite power station comprising:
a composite energy storage arrangement having at least one stationary element and at least one mobile element;
a composite power import processing arrangement configured to supply power to at least one of the stationary element and the mobile element;
a composite power export processing arrangement configured to export power from at least one of the stationary element and the mobile element to at least one of the equipment items, attachments, vehicles, and power consumers
a composite power import allocation arrangement communicatively connected to at least one of the stationary element and the mobile element configured to selectively allocate power imported to at least one of the stationary element and the mobile element;
a composite power export allocation arrangement communicatively connected to at least one of the stationary element and the mobile element configured to selectively export power from at least one of the stationary element and the mobile element; and
at least one of a photovoltaic panel, a wind turbine, and a generator configured to supply power to the composite energy storage arrangement,
wherein the mobile element comprises an electrically-powered mobile work platform (MWP), which includes a first end and a second end generally opposite the first end and a first attachment interface connected to the first end and a second attachment interface connected to the second end, and wherein the electrically-powered MWP serves as a mobile energy storage and power export element, wherein the electrically-powered MWP is configured to operably couple with and operate at least one of the attachments on either, or simultaneously on both, of the first attachment interface and the second attachment, and wherein the MWP includes at least one of maximum power point tracking (MPPT) and electrical vehicle supply equipment (EVSE).

2. The composite power station of claim 1, further comprising:
a logic arrangement that sizes capacities of the composite energy storage arrangement.

3. The composite power station of claim 1, further comprising:
a logic arrangement that determines how much power is to be imported by the composite power import processing arrangement.

4. The composite power station of claim 1, further comprising:
a logic arrangement that determines how much power is to be supplied to the composite power import processing arrangement.

5. The composite power station of claim 1, further comprising:
a logic arrangement that determines how much power is to be imported to the stationary element and the mobile element.

6. The composite power station of claim 1, further comprising:
a logic arrangement that determines how much power is to be allocated from the stationary element and the mobile element.

7. The composite power station of claim 1, further comprising:
a logic arrangement that determines how much power is to be taken from the stationary element and the mobile element.

8. The composite power station of claim 1, further comprising:
a logic arrangement that determines how much power is to be provided to predetermined power consumers.

9. The composite power station of claim 1, further comprising:
an integrated oversight and control logic arrangement an integrated oversight and control logic arrangement configured to control the composite energy storage arrangement, the composite power import processing arrangement, the composite power export processing arrangement, the composite power import allocation arrangement, and the composite power export allocation arrangement.

10. A composite power station for use in connection with equipment items, attachments, vehicles, source power, and power consumers, the composite power station comprising:
a composite energy storage arrangement having at least one stationary element and at least one mobile element;
a composite power import processing arrangement configured to supply power to at least one of the stationary element and the mobile element, wherein the composite power import processing arrangement is configured for processing, using one or more of the at least one stationary element and the at least one mobile element, the source power into one or more forms suitable for storage in the composite energy storage arrangement;
a composite power export processing arrangement configured to export power from at least one of the stationary element and the mobile element to at least one of the equipment items, vehicles, and power consumers, wherein the composite power export processing arrangement is configured for processing, using one or more of the at least one stationary element and the at least one mobile element, the power stored in the composite energy storage arrangement into one or more forms suitable for the at least one of the equipment items, vehicles, and power consumers;
a composite power import allocation arrangement configured to selectively allocate power imported to at least one of the stationary element and the mobile element;
a composite power export allocation arrangement configured to selectively export power from at least one of the stationary element and the mobile element;
at least one of a photovoltaic panel, a wind turbine, and a generator configured to supply power to the composite energy storage arrangement;
a logic arrangement that determines how much power is to be imported to the stationary element and the mobile element;
a logic arrangement that determines how much power is to be allocated from the stationary element and the mobile element; and
a logic arrangement that determines how much power is to be taken from the stationary element and the mobile element,
wherein the mobile element comprises an electrically-powered mobile work platform (MWP), which includes a first end and a second end generally opposite the first end and a first attachment interface connected to the first end and a second attachment interface connected to the second end, and wherein the electrically-powered MWP serves as a mobile energy storage and power export element, wherein the electrically-powered MWP, while not coupled to another vehicle, is configured to operably couple with and operate at least one of the attachments on either, or simultaneously on both, of the first attachment interface and the second attachment, wherein the first end of the platform also includes a first steering mechanism and the second end includes a second steering mechanism, whereby the electrically-powered MWP is configured to be propelled and steered in a first direction and propelled and steered in a second direction generally opposite the first direction by the first and second steering mechanisms, respectively, and wherein the MWP includes at least one of maximum power point tracking (MPPT) and electrical vehicle supply equipment (EVSE).

11. The composite power station of claim 10, further comprising:
a logic arrangement that sizes capacities of the composite energy storage arrangement;
a logic arrangement that determines how much power is to be imported by the composite power import processing arrangement;
a logic arrangement that determines how much power is to be exported from composite power import processing arrangement; and
a logic arrangement that determines how much power is to be provided to predetermined power consumers.

12. The composite power station of claim 11, further comprising:
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the logic arrangement that determines how much power is to be imported to the stationary element and the mobile element, the logic arrangement that determines how much power is to be allocated from the stationary element and the mobile element, and the logic arrangement that determines how much power is to be taken from the stationary element and the mobile element.

13. A method, comprising:
providing a composite energy storage arrangement having at least one stationary element and at least one mobile element;
providing a composite power import processing arrangement configured to supply power to at least one of the stationary element and the mobile element, wherein the composite power import processing arrangement is configured for processing, using one or more of the at least one stationary element and the at least one mobile element, a source power into one or more forms suitable for storage in the composite energy storage arrangement;
providing a composite power export processing arrangement configured to export power from at least one of the stationary element and the mobile element to at least one of the equipment items, vehicles, and power consumers, wherein the composite power export processing arrangement is configured for processing, using one or more of the at least one stationary element and the at least one mobile element, the power stored in the composite energy storage arrangement into one or more forms suitable for the at least one of the equipment items, vehicles, and power consumers;
providing a composite power import allocation arrangement configured to selectively allocate power imported to at least one of the stationary element and the mobile element;
providing a composite power export allocation arrangement configured to selectively export power from at least one of the stationary element and the mobile element;
providing at least one of a photovoltaic panel, a wind turbine, and a generator configured to supply power to the composite energy storage arrangement configured to supply power to the composite energy storage arrangement;
providing a first logic arrangement that determines at least one of the amount of power to be imported to the stationary element and the mobile element, the amount of power to be allocated from the stationary element and the mobile element, and the amount of power to be taken from the stationary element and the mobile element;
providing an integrated oversight and control logic arrangement; and
using the integrated oversight and control logic arrangement to the composite energy storage arrangement, the composite power import processing arrangement, the composite power export processing arrangement, the composite power import allocation arrangement, and the composite power export allocation arrangement,
wherein the mobile element comprises an electrically-powered mobile work platform (MWP), which includes a first end and a second end generally opposite the first end and a first attachment interface connected to the first end and a second attachment interface connected to the second end, and wherein the electrically-powered MWP serves as a mobile energy storage and power export element, wherein the electrically-powered MWP is configured to operably couple with and operate at least one of the attachments on either, or simultaneously on both, of the first attachment interface and the second attachment, and wherein the MWP includes at least one of maximum power point tracking (MPPT) and electrical vehicle supply equipment (EVSE).

14. The method of claim 13, further comprising:
providing a first logic arrangement that determines at least one of the amount of power to be imported to the stationary element and the mobile element, the amount of power to be allocated from the stationary element and the mobile element, the amount of power to be taken from the stationary element and the mobile element; and
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, and the first logic arrangement.

15. The method of claim 14, further comprising:
providing a second logic arrangement that sizes capacities of the composite energy storage arrangement; and
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the first logic arrangement, and the second logic arrangement.

16. The method of claim 15, further comprising:
providing a third logic arrangement that determines how much power is to be imported by the composite power import processing arrangement; and
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the first logic arrangement, the second logic arrangement, and the third logic arrangement.

17. The method of claim 16, further comprising:
providing a fourth logic arrangement that determines how much power is to be exported from composite power import processing arrangement; and
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the first logic arrangement, the second logic arrangement, the third logic arrangement, and the fourth logic arrangement.

18. The method of claim 17, further comprising:
providing a fifth logic arrangement that determines how much power is to be imported to the stationary element and the mobile element.
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the first logic arrangement, the second logic arrangement, the third logic arrangement, the fourth logic arrangement, and the fifth logic arrangement.

19. The method of claim 18, further comprising:
providing a sixth logic arrangement that determines how much power is to be taken from the stationary element and the mobile element; and
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the first logic arrangement, the second logic arrangement, the third logic arrangement, the fourth logic arrangement, the fifth logic arrangement, and the sixth logic arrangement.

20. The method of claim 19, further comprising:
providing a seventh logic arrangement that determines how much power is to be provided to predetermined power consumers; and
an integrated oversight and control logic arrangement configured to control at least two different ones of the following: the composite energy storage arrangement, the composite power import processing arrangement, the composite power export processing arrangement, the composite power import allocation arrangement, the composite power export allocation arrangement, the first logic arrangement, the second logic arrangement, the third logic arrangement, the fourth logic arrangement, the fifth logic arrangement, the sixth logic arrangement, and the seventh logic arrangement.
